(19) United States
(12) Patent Application Publication
(10) Pub. No.: US 2008/0310844 A1
(43) Pub. Date: Dec. 18, 2008

(54) Hybrid Optoelectronic Module

(75) Inventors: Libing Zhou, Shenzhen (CN); Zeqin Wang, Shenzhen (CN); Hong Xie, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: O-NET COMMUNICATIONS LIMITED, Shenzhen, Guangdong Province (CN)

(21) Appl. No.: 11/572,179

(22) PCT Filed: Aug. 28, 2006
(86) PCT No.: PCT/CN06/02211

§ 371 Date: Jan. 16, 2007

(30) Foreign Application Priority Data
Aug. 29, 2005 (CN) 200520200617.4

(51) Int. Cl. H04J 14/02

(52) U.S. Cl. 398/79

(57) ABSTRACT

A hybrid optoelectronic module used in duplexer or triplexer includes a transmitter chip for emitting a first signal beam at wavelength λ1, a single fiber for transmitting the first signal beam at wavelength λ1 and a second signal beam at wavelength λ2, a WDM filter for transmitting the first signal beam and reflecting the second signal beam, and a detective chip for receiving the second signal beam at wavelength λ2. The transmitter chip, the WDM filter and the detective chip are assembled together in an optical bench, the arrangement of these passive and active components is removed from TO-CAN structure so that packaging assembly requirements may be greatly reduced and turn to be convenient in manufacturing process.

### BACKGROUND OF THE INVENTION

1. Field of the Invention

The present invention generally relates to active optoelectronic devices and more particularly to a hybrid optoelectronic module which is preferably used in duplexer and triplexer, these optical modules are often used in fiber-to-the-home (FTTH) systems.

2. Background of the Invention

With the development and increasing maturity of optical communication technology and market, the optical communications industry has already advanced to optical access network. Devices and modules of duplexer, or triplexer employed in FTTH (Fiber to the Home) network have emerged in the industry and the market, which realize the transmission of the multi-wavelength optical signals in a single fiber, thus meet the increasing requirements on voice and data telecommunication, especially, which are also required to provide analog or digital TV signal transmission.

Generally, the conventional optical duplexers and triplexer modules are all based on coaxial TO-CAN packaging assembly, for example, a triplexer module shown in FIG. 1. The triplexer module disclosed in FIG. 1 includes a single fiber 31, a TO-CAN packaged laser device 32 including a first lens 41, a first filter 33, and a second filter 34 in an alignment in the optical axis of the module, a first TO-CAN packaged detective device 35 including a second lens 42, and a second TO-CAN packaged detective device 36 including a third lens 43. Alternatively, the first filter 33 and the second filter 34 can also be thin film filter, which can reflect as well as transmit different wavelength band beams. A first signal beam at wavelength λ1 emitted by the laser 32 focused into the single fiber 31 by the first lens 41, via the first filter 33 and the second filter 34. A second signal beam at wavelength λ2 inputted from the single fiber 31 is reflected by the first filter 33, via the second filter 34, and then is focused into the second detective device 36 by the second lens 43. A third signal beam at wavelength λ3 inputted from the single fiber 31 is reflected by the second filter 33, and then is focused into the first detective device 35 by the second lens 42.

As disclosed above, the TO-CAN packaged laser device 32 is encapsulated to a TO-CAN package with the corresponding lens 41, the first TO-CAN packaged detective device 35 is encapsulated to a TO-CAN package with the corresponding lens 42, and the second TO-CAN packaged detective device 36 is encapsulated to a TO-CAN package with the corresponding lens 43. Then the single fiber 31, the first filter 33, the second filter 34 with the device 32, 35 and 36 are assembled together. All these devices are maintained in a module housing and an optoelectronic module is achieved.

However, the structure of the above-mentioned conventional optoelectronic module has some disadvantages. For example, the arrangement of the pins of the module on a base of the TO-CAN package are restricted by the TO-CAN packaged laser 32, the first TO-CAN packaged detective device 35, and the second TO-CAN packaged detective device 36 design so the allocation of these devices turn to be asymmetric and irregular. Furthermore, such TO-CAN packaged device and internal filters are directly fixed to the metal housing. Which has material unmatched issue and cause potential stability problem, thirdly, since the eccentricity of the TO-CAN packaged device 32, 35, 36 easily affected coupling efficient. Additionally, the whole assembly process will be not flexible, hard for mass-production and entail increased expenditure.

Therefore, there is need for a configuration of integrating optoelectronic devices to improve assembly flexibility, simplicity, good consistency, lower cost, as well as high reliability.

### SUMMARY OF THE INVENTION

The present invention generally provides a hybrid optoelectronic module with simpler process improved assembly flexibility, good consistency, lower cost, as well as high reliability.

One embodiment provides a hybrid optoelectronic module including a transmitter chip for emitting a first signal beam at wavelength λ1, a single fiber for transmitting said first signal beam at wavelength λ1 and a second signal beam at wavelength λ2, a WDM filter for transmitting the first signal beam and reflecting the second signal beam, and a detective chip for receiving the second signal beam at wavelength λ2. The transmitter chip, the WDM filter and the detective chip are assembled together in an optical bench.

Another embodiment provides a hybrid optoelectronic module for single fiber tri-directional transmission scheme including a transmitter chip for emitting a first signal beam at wavelength λ1, a single fiber for receiving and transmitting said first signal beam at wavelength λ1, and transmitting a second signal beam at wavelength λ2 and a third signal beam at wavelength λ3, a WDM filter comprising a first filter and a second filter for transmitting and/or reflecting the first signal beam, the second signal beam, and the third signal beam, a first detective chip for receiving the third signal beam at wavelength λ3, and a second detective chip for receiving the second signal beam at wavelength λ2. The transmitter chip, the WDM filter, the first detective chip and the second detective chip are assembled together in an optical bench.

The construction and method of operation of the invention, however, together with additional objects and advantages thereof will be best understood from the following description of specific embodiments when read in connection with the accompanying drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, in that the invention may admit to other equally effective embodiments.

FIG. 1 illustrates an exemplary triplexer packaging module in accordance with the prior art;

FIG. 2 is a structure diagram of an exemplary hybrid optoelectronic module in accordance with a first embodiment of the present invention;

FIG. 3 is a structure diagram of an exemplary hybrid optoelectronic module in accordance with a second embodiment of the present invention;

### DETAILED DESCRIPTION

In the following description, numerous specific details are given to provide a thorough understanding of the invention. However, it will be apparent that the invention may be practised without these specific details. In order to avoid obscuring the present invention, some well-known system configurations are not disclosed in detail.

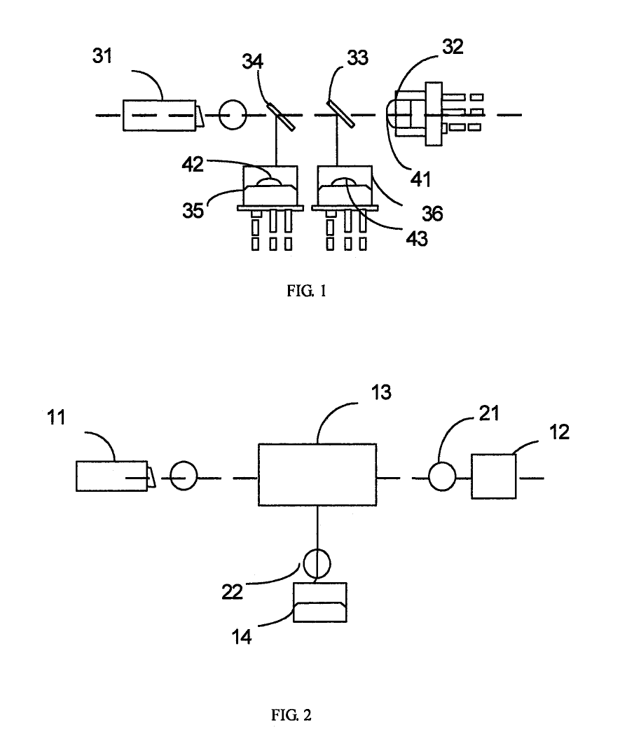

Referring to FIG. 2, a hybrid optoelectronic module in accordance with a first embodiment of the present invention comprises of a single fiber 11, a transmitter chip 12, a WDM (Wavelength Division Multiplexing) filter 13 placed between the single fiber 11 and the transmitter chip 12, and a detective chip 14.

A first lens 21 is placed between the filter 13 and the transmitter chip 12; a second lens 22 is placed between the filter 13 and the detective chip 14.

Alternatively, The WDM filter 13 may be a thin film filter.

The transmitter chip 12 emits a first signal beam at wavelength λ1. The WDM filter 13 transmit light at wavelength λ1 and reflect light at wavelength λ2. The detective chip 14 receives the second signal beam at wavelength 2 from the single fiber 11. The single fiber 11 also transmits the second signal beam at wavelength λ2.

λ1 may be 1310±50 nm. λ2 may be 1490±10 nm.

In this embodiment, a light path in accordance with the present invention is described below. The first signal beam at wavelength λ1 is emitted by the transmitter chip 12. The first signal beam is focused into the single fiber 11 by the first lens 21, via the WDM filter 13. The second signal beam at wavelength λ2 from the single fiber 11 is reflected by the WDM filter 13, and sequentially focused into the detective chip 14 by the second lens 22.

As illustrated in this exemplary arrangement, the transmitter chip 12, the detective chip 14, together with other optical elements, are assembled directly in one optical bench. This design can be easily customized and compact, and this process can ensure good consistency and easily transfer to mass product.

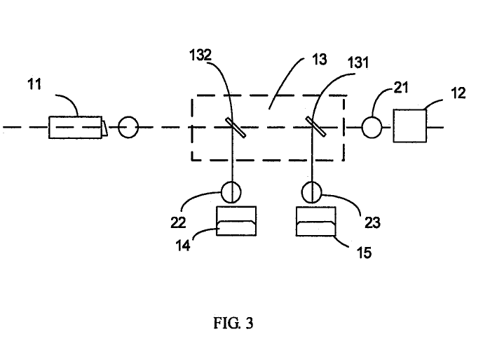

Referring to FIG. 3, a hybrid optoelectronic module in accordance with a second embodiment of the present invention comprises of a single fiber 11, a transmitter chip 12, a WDM (Wavelength Division Multiplexing) filter 13 placed between the single fiber 11 and the transmitter chip 12, a first detective chip 14, and a second detective chip 15.

The transmitter chip 12 emits a first signal beam at wavelength λ1. The single fiber 11 receives and transmits the first signal beam at wavelength λ1 and transmits a second signal beam at wavelength λ2 and a third signal beam at wavelength λ3.

The WDM filter 13 comprises of a first filter 131 and a second filter 132. The first filter 131 transmits light at wavelength λ1 and reflects light at wavelength λ2. The second filter 132 transmits light at wavelength λ1, λ2 and reflects light at wavelength λ3. The first detective chip 14 receives light at wavelength λ3, and the second detective chip 15 receives light at wavelength λ2.

λ1 may be 1310±50 nm. λ2 may be 1490±10 nm, and λ3 may be 1550±10 nm.

The transmitter chip 12 has a front end to emit the first signal beam at wavelength λ1. A first lens 21 is placed between the transmitter chip 12 and the first filter 131. The first detective chip 14 receives the light at wavelength λ3. A second lens 22 is placed between the first detective chip 14 and the second filter 132. The second detective chip 15 receives the light at wavelength λ2. A third lens 23 is placed between the second detective chip 15 and the first filter 131.

In this embodiment, a light path in accordance with the present invention is described below. The first signal beam at wavelength λ1 is emitted by the transmitter chip 12. The first signal beam focus into the single fiber 11 by the first lens 21, via the WDM filter 13. The third signal beam at wavelength λ3 is inputted from the single fiber 11 is reflected by the second filter 132, and sequentially is focused into the first detective chip 14 by the second lens 22. The second signal beam at wavelength λ2 is reflected by the first filter 131 and is finally focused into the second detective chip 15 by the third lens 23, via the second filter 132.

In this embodiment, the first filter 131 and the second filter 132 are placed parallel or vertical to each other.

As illustrated in this exemplary arrangement, the transmitter chip 12, the first detective chip 14, and the second detective chip 15, together with other optical elements are assembled directly in one optical bench. This design can be easily customized and compact. Furthermore, this process can ensure good consistency and easily transfer to mass product.

Consequently, embodiments of the present invention provide hybrid optoelectronic modules with competitive cost and compact package by integrating transmitter chips, detective chips and all other elements together. Furthermore, the arrangement of these passive and active components is removed from TO-CAN structure so that packaging assembly requirements may be greatly reduced and turn to be convenient in manufacturing process. Hybrid optoelectronic modules provided in accordance with the present invention can be utilized in optical fiber communication network, especially in broadband access communication networking.

While the foregoing is directed to embodiments of the present invention, other and further embodiments of the invention may be devised without departing from the basic scope thereof, and the scope thereof is determined by the claims that follow.

1-9. (canceled)

10. A hybrid optoelectronic module, comprising:
a transmitter chip for emitting a first signal beam at wavelength λ1,
a single fiber for transmitting said first signal beam at wavelength λ1 and a second signal beam at wavelength λ2,
a WDM filter for transmitting the first signal beam and reflecting the second signal beam, and
a detective chip for receiving the second signal beam at wavelength λ2,
wherein the transmitter chip, the WDM filter and the detective chip are assembled together in an optical bench.

11. The hybrid optoelectronic module of claim 10, wherein the single fiber may be assembled with the transmitter chip, the WDM filter and the detective chip.

12. The hybrid optoelectronic module of claim 10, wherein λ1 may be 1310±50 nm.

13. The hybrid optoelectronic module of claim 11, wherein λ2 may be 1490±10 nm.

14. The hybrid optoelectronic module of claim 10, further comprises a first lens placed between the WDM filter and the transmitter chip.

15. The hybrid optoelectronic module of claim 10, further comprises a second lens placed between the WDM filter and the detective chip.

16. The hybrid optoelectronic module of claim 10, wherein said WDM filter may be a thin film filter.

17. A hybrid optoelectronic module for single fiber tri-directional transmission scheme, comprising:
a transmitter chip for emitting a first signal beam at wavelength λ1,
a single fiber for receiving and transmitting said first signal beam at wavelength λ1, and transmitting a second signal beam at wavelength λ2 and a third signal beam at wavelength λ3,
a WDM filter comprising a first filter and a second filter for transmitting and/or reflecting the first signal beam, the second signal beam, and the third signal beam,
a first detective chip for receiving the third signal beam at wavelength λ3, and
a second detective chip for receiving the second signal beam at wavelength λ2,
wherein the transmitter chip, the WDM filter, the first detective chip and the second detective chip are assembled together in an optical bench.

18. The hybrid optoelectronic module of claim 17, wherein the single fiber may be assembled with the transmitter chip, the WDM filter, the first detective chip and the second detective chip.

19. The hybrid optoelectronic module of claim 17, wherein λ1 may be 1310±50 nm, λ2 may be 1490±10 nm, and λ3 may be 1550±10 nm.

20. The hybrid optoelectronic module of claim 17, wherein the transmitter chip has a front end for emitting the first signal beam at wavelength λ1.

21. The hybrid optoelectronic module of claim 17, further comprises a first lens placed between the transmitter chip and the first filter.

22. The hybrid optoelectronic module of claim 17, further comprises a second lens placed between the first detective chip and the second filter.

23. The hybrid optoelectronic module of claim 17, further comprises a third lens placed between the second detective chip and the first filter.

24. The hybrid optoelectronic module of claim 17, wherein the first filter and the second filter may be thin film filters.

25. The hybrid optoelectronic module of claim 17, wherein the first filter and the second filter are positioned parallel to each other.

26. The hybrid optoelectronic module of claim 17, wherein the first filter and the second filter are positioned vertical to each other.
